(19) United States
(12) Patent Application Publication
(10) Pub. No.: US 2012/0187019 A1
(43) Pub. Date: Jul. 26, 2012

(54) Methods to Produce Semi-Durable Foamed Articles

(75) Inventors: Jon Tippet, League City, TX (US); Leland Daniels, Dayton, TX (US); Juan Gonzalez, Houston, TX (US)

(73) Assignee: FINA TECHNOLOGY, INC., Houston, TX (US)

(21) Appl. No.: 13/334,270

(22) Filed: Dec. 22, 2011

Related U.S. Application Data
(60) Provisional application No. 61/434,625, filed on Jan. 20, 2011.

(51) Int. Cl. B65D 81/00; B29C 51/02; B29C 47/06

(52) U.S. Cl. 206/524.6; 264/46.8; 220/592.01

(57) ABSTRACT

A method of making a container including thermoforming a polymeric sheet containing at least one foam layer and optionally having one or more solid layer(s) disposed adjacent to the foam layer and shaping the polymeric sheet into a container, wherein the container is an insulator and wherein the layers of the sheet are adhered to each other.

### CROSS-REFERENCE TO RELATED APPLICATIONS

The present application claims priority to U.S. provisional patent 61/434,625 filed Jan. 20, 2011.

### FIELD

The present invention is generally related to methods of making polymeric articles. More specifically, the present invention is generally related to improved methods of making semi-durable and/or disposable foamed polymeric articles.

### BACKGROUND

Thermoformed polymeric articles include many consumer products including coolers. Coolers typically include insulated boxes or other containers that may be used to keep food and drink under cool temperatures or optionally under elevated temperatures. A variety of coolers are currently available. Examples of durable, or rigid coolers are coolers from the Playmate® line produced by Igloo Products, Inc. The body of the Playmate® is made of a three piece construction including an injection molded polypropylene liner, an injection molded polypropylene outer shell, and a urethane foam insulation situated between the liner and the outer shell. This construction results in a very durable container. However, such a cooler has a high cost that would limit disposability of the container, because buying these durable coolers as replacement coolers on a need basis would prove expensive.

In order to obtain a cost effective disposable cooler, many customers turn to disposable foam containers or coolers. These foam coolers are typically made from a single layer of expanded polystyrene. These foam coolers are usually susceptible to breaking due to the brittle properties of expanded polystyrene. In addition, these foam coolers usually have loose fitting lids because of the typical absence of a hard outer surface/shell on which to attach a tight fitting lid. Furthermore, the foam surface of the foam coolers does not provide a quality surface for labels or printing as the hard, glossy surface of a durable cooler does, such as the Playmate®. It would therefore be desirable to have an inexpensive, and possibly disposable, cooler having the benefits of durable, rigid coolers.

### SUMMARY

Disclosed herein is a method of preparing a disposable cooler including forming a polymeric sheet containing at least one foam layer and shaping the multilayer polymeric sheet into the form of a cooler or liner. The polymeric sheet can be a multilayer polymeric sheet containing at least one foam layer and at least one solid layer disposed adjacent to the foam layer. The layers of the sheet can be adhered to each other, such as by coextrusion.

Further disclosed herein is a method of preparing a disposable cooler including coextruding a foamed polystyrene layer between two solid layers of high impact polystyrene to form a sheet, and thermoforming the sheet into a disposable cooler.

Also disclosed herein is a method of forming a multilayer polymeric sheet including melting a first styrenic polymer composition, melting and foaming a second styrenic polymer composition, and coextruding the first and second styrenic polymer compositions to form a multilayer polymeric sheet.

Also disclosed herein is a method of reducing the weight of a multilayer polymeric article including preparing a multilayer article by coextrusion of a polymeric composition, wherein the polymeric composition comprises a high impact polystyrene and at least one of the layers was foamed by incorporation of a chemical blowing agent.

### BRIEF DESCRIPTION OF DRAWINGS

FIG. 1 is an illustration of a weight reduced polymeric sheet having multiple layers.

FIG. 2 is a plot of Gardner impact as a function of density for the samples from Example 1.

FIG. 3 is a plot of tensile strength properties for the samples from Example 1.

FIG. 4 is a photomicrograph of a foamed inner core layer for Sample 4 from Example 1.

FIG. 5 is a photo of a prototype part made with an embodiment of the present invention.

FIG. 6 is a photo of a prototype part made with an embodiment of the present invention.

FIG. 7 is a photo of a prototype part made with an embodiment of the present invention.

FIG. 8 is a photo of two sheets of foam board adhered during thermoforming process in accordance with an embodiment of the present invention.

### DETAILED DESCRIPTION

The present invention includes an article of manufacture and a method of making the same, wherein the article of manufacture can include a cooler.

The article of manufacture and a method of making the same may include polymeric articles having a reduced weight, such as with foamed or expanded polymeric component, which may also be referred to as reduced weight polymeric articles (RWPAs). The present invention may also include methods of making and using RWPAs. In an embodiment, the polymeric article includes at least one polymeric sheet wherein the at least one sheet/layer includes a foamed polymeric composition.

In an embodiment, the RWPA is a multilayered polymeric article. In another embodiment, the RWPA includes one or more non-foamed polymer layers and at least one foamed polymer layer. The non-foamed polymer layer is also referred to herein as a “solid” polymer layer. In an embodiment, the solid polymer layers and foamed polymer layers include different polymeric materials. Examples of suitable polymeric materials include without limitation homopolymers and copolymers of polyolefins (e.g., polypropylene, polyethylene), polyethylene terephthalate, polyvinyl chloride, polyvinylidine chloride, polylactic acid, polyamide, polycarbonate, polytetrafluoroethylene, polyurethane, polyester, polymethyl methacrylate, polyoxymethylene, styrenic polymers, or combinations thereof.

In an embodiment, the polymeric material includes a styrenic polymer, such as polystyrene, wherein the styrenic polymer may be a styrenic homopolymer or a styrenic copolymer. In an embodiment, one or more styrene compounds are used as monomers for the formation of the styrenic polymer. Styrene, also known as vinyl benzene, ethylenylbenzene, and phenylethene is an organic compound represented by the chemical formula C₈H₈. As used herein the term styrene includes a variety of substituted styrenes (e.g., alpha-methyl styrene), ring substituted styrene such as p-methylstyrene and p-t-butyl styrene, as well as unsubstituted styrenes. In an embodiment, one or more layers and/or one or more foamed layers of the RWPA include a styrenic polymer.

In an embodiment, the styrenic polymer is present in a reaction mixture used to prepare one or more layers of the RWPA in amounts from 1.0 to 99.9 weight percent (wt. %) by total weight of the mixture. In another embodiment, the styrenic polymer is present in amounts from 50 to 99 wt. %. In a further embodiment, the styrenic polymer is present in amounts from 90 to 99 wt. %.

In an embodiment, the styrenic polymer is a styrenic copolymer including styrene and one or more comonomers. Examples of comonomers may include without limitation α-methylstyrene; halogenated styrenes; alkylated styrenes; acrylonitrile; esters of (meth)acrylic acid with alcohols having 1 to 8 carbons; N-vinyl compounds such as vinylcarbazole, maleic anhydride; compounds which contain two polymerizable double bonds such as divinylbenzene or butanediol diacrylate; or combinations thereof. In an embodiment, the comonomer may be present in an amount effective to impart one or more user-desired properties to the composition. Such effective amounts may be determined by one of ordinary skill in the art with the aid of this disclosure. For example, the comonomer may be in a reaction mixture used to prepare one or more layers of a RWPA in an amount ranging from 1 to 99.9 wt. % by total weight of the reaction mixture. In another embodiment, the comonomer is present in the reaction mixture in an amount ranging from 1 to 90 wt. %. In a further embodiment, the comonomer is present in the reaction mixture in an amount ranging from 1 to 50 wt. %.

Rubber-reinforced polymers of monovinylaromatic compounds, such as styrene, α-methylstyrene and ring-substituted styrenes are desirable for a variety of applications including refrigerator linings and packaging applications. The conventional term for such rubber reinforced polymers is “High Impact Polystyrene” or “HIPS”. In an embodiment, one or more solid layers and/or one or more foamed layers of the RWPA may include a high impact polystyrene (HIPS). HIPS contains an elastomeric phase that is embedded in the styrenic polymer resulting in the composition having an increased impact resistance. In an embodiment, one or more solid layers and/or one or more foamed layers of the RWPA may include a HIPS having a conjugated diene monomer based material as the elastomer. Examples of suitable conjugated diene monomers include without limitation 1,3-butadiene, 2-methyl-1,3-butadiene, and 2 chloro-1,3 butadiene. In another embodiment, the rubber reinforced polymer includes a HIPS having an aliphatic conjugated diene monomer based material as the elastomer. Examples of suitable aliphatic diene monomers include, without limitation, C₄ to C₉ dienes such as butadiene monomers. The elastomeric component may also include blends or copolymers of the diene monomers. HIPS may be manufactured in accordance with any conventional process. Conventional manufacturing processes include mass polymerization and solution polymerization such as that disclosed in U.S. Pat. No. 2,694,692 or mass suspension polymerization such as that disclosed in U.S. Pat. No. 2,862,906. Other processes of manufacture may also be used.

The elastomer may be present in amounts effective to produce one or more user-desired properties. Such effective amounts may be determined by one having ordinary skill in the art with the aid of this disclosure. In an embodiment, the level of elastomer utilized is in an amount ranging from 0.1 to 50 wt. % by weight of solution. In another embodiment, the level of elastomer utilized is in an amount ranging from 0.5 to 40 wt. %. In a further embodiment, the level of elastomer utilized is in an amount ranging from 1 to 30 wt. %. In an even further embodiment, the level of elastomer utilized is in the range of about 5 to 15 wt. %.

In an embodiment, one or more solid layers and/or one or more foamed layers of the RWPA may include a styrenic polymer generally having the properties set forth in Table 1A.

TABLE 1A

| Properties | Test method | Range 1 | Range 2 | Range 3 |
|---|---|---|---|---|
| Melt-mass flow | ASTM D1238 | 1-14 | 1.5-6 | 2-4 |
| rate (g/10 min.) | | | | |
| Gardner impact | ASTM D 3029 | 0-180 | 80-140 | 100-120 |
| (in-lb) | | | | |
| Notched Izod | ASTM D-256 | 0.5-4.0 | 1.5-3.5 | 2.0-3.0 |
| impact strength | | | | |
| (ft. lb/in) | | | | |
| Tensile strength | ASTM D-638 | 1500-8000 | 1800-4000 | 2000-3000 |
| (psi) | | | | |
| Tensile modulus, | ASTM D-638 | 1.0-5.0 | 1.5-3.0 | 2.0-2.5 |
| 10⁵ (psi) | | | | |
| Elongation (%) | ASTM D-638 | 5-90 | 50-95 | 60-80 |
| Flexural strength | ASTM D-790 | 3000-14500 | 4000-7000 | 4500-5500 |
| (psi) | | | | |
| Flexural modulus, | ASTM D-790 | 1.0-5.0 | 1.5-3.5 | 2.0-3.0 |
| 10⁵ (psi) | | | | |
| Heat distortion | ASTM D-648 | 185-210 | 190-205 | 195-200 |
| temperature (° F.) | | | | |
| Vicat temperature | ASTM D-1525 | 195-225 | 200-220 | 205-215 |
| Gloss 60° | ASTM D-523 | 40-100 | 45-85 | 50-65 |

Examples of styrenic copolymers suitable for use in forming one or more layers of the RWPA include without limitation styrene butadiene rubber (SBR), acrylonitrile butadiene styrene (ABS), styrene acrylonitrile (SAN), and the like. A styrenic polymer suitable for use in forming one or more layers of the RWPA includes without limitation 960E, which is a commercially available HIPS from Total Petrochemicals USA, Inc. In an embodiment, the styrenic polymer (e.g., 960E) has generally the physical properties set forth in Table 1B.

TABLE 1B

| | 960E | |
|---|---|---|
| Properties | Typical Value | Test Method |
| Melt flow rate (MFR), g/10 min. | 3.8 | ASTM D-1238 |
| Impact properties | | |
| Gardner impact, in-lb | 110 | ASTM D-3029 |
| Notched Izod impact strength, ft lb/in | 3.0 | ASTM D-256 |
| Tensile properties | | |
| Tensile strength, psi | 2,500 | ASTM D-638 |
| Tensile modulus, psi (10⁵) | 2.3 | ASTM D-638 |
| Elongation, % | 70 | ASTM D-638 |
| Flexural properties | | |
| Flexural strength, psi | 4,800 | ASTM D-790 |
| Flexural modulus, psi (10⁵) | 2.4 | ASTM D-790 |
| Thermal properties | | |
| Heat distortion temperature, ° F. | 197 | ASTM D-648 |
| Vicat temperature, ° F. | 210 | ASTM D-1525 |
| Physical properties | | |
| Gloss, 60° | 57 | ASTM D-523 |

In an embodiment, a process for the production of the styrenic polymer includes contacting the styrenic monomer, and optionally one or more comonomers, with at least one initiator. Any initiator capable of free radical formation that facilitates the polymerization of styrene may be employed. Such initiators include by way of example and without limitation organic peroxides. Examples of organic peroxides useful for polymerization initiation include without limitation diacyl peroxides, peroxydicarbonates, monoperoxycarbonates, peroxyketals, peroxyesters, dialkyl peroxides, hydroperoxides or combinations thereof. In an embodiment, the initiator level in the reaction mixture is given in terms of the active oxygen in parts per million (ppm). For example, the level of active oxygen in the disclosed reactions for the production of the styrenic polymer is from 20 ppm to 80 ppm, alternatively from 20 ppm to 60 ppm, alternatively from 30 ppm to 60 ppm. As will be understood by one of ordinary skill in the art, the selection of initiator and effective amount will depend on numerous factors (e.g., temperature, reaction time) and can be chosen by one of ordinary skill in the art with the benefits of this disclosure to meet the desired needs of the process. Polymerization initiators and their effective amounts have been described in U.S. Pat. Nos. 6,822,046; 4,861,127; 5,559,162; 4,433,099 and 7,179,873 each of which are incorporated by reference herein in their entirety.

In an embodiment, one or more layers of the RWPA include a HIPS, wherein the elastomer includes polybutadiene. In an embodiment, a method for the production of the HIPS includes the dissolution of polybutadiene (PB) elastomer in styrene that is subsequently polymerized. During polymerization, a phase separation based on the immiscibility of polystyrene (PS) and polybutadiene (PB) occurs in two stages. Initially, the PB forms the major or continuous phase with styrene dispersed therein. As the reaction begins, PS droplets form and are dispersed in an elastomer solution of PB and styrene monomer. As the reaction progresses and the amount of polystyrene continues to increase, a morphological transformation or phase inversion occurs such that the PS now forms the continuous phase and the PB and styrene monomer forms the discontinuous phase. This phase inversion leads to formation of the discontinuous phase including complex elastomeric particles in which the elastomer exists in the form of PB membranes surrounding occluded domains of PS.

The polymerization reaction for formation of the polymeric material (i.e. HIPS) used to prepare the one or more layers of the RWPA may be represented by the chemical equations given below:

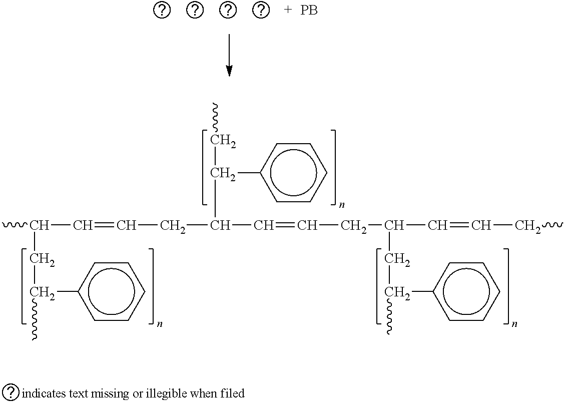

In an embodiment, the polymerization reaction to form the polymeric material (i.e., HIPS) may be carried out in a solution or mass polymerization process. Mass polymerization, also known as bulk polymerization refers to the polymerization of a monomer in the absence of any medium other than the monomer and a catalyst or polymerization initiator. Solution polymerization refers to a polymerization process in which the monomers and polymerization initiators are dissolved in a non-monomeric liquid solvent at the beginning of the polymerization reaction. The liquid is usually also a solvent for the resulting polymer or copolymer.

The polymerization process can be either batch or continuous. In an embodiment, the polymerization reaction may be carried out using a continuous production process in a polymerization apparatus including a single reactor or a plurality of reactors. Reactors and conditions for the production of a polymeric composition, specifically polystyrene, are disclosed in U.S. Pat. No. 4,777,210, which is incorporated by reference herein in its entirety.

The temperature ranges useful with the process of the present disclosure can be selected to be consistent with the operational characteristics of the equipment used to perform the polymerization. In one embodiment, the temperature range for the polymerization can be from 90° C. to 240° C. In another embodiment, the temperature range for the polymerization can be from 100° C. to 180° C. In yet another embodiment, the polymerization reaction may be carried out in a plurality of reactors with each reactor having an optimum temperature range. For example, the polymerization reaction may be carried out in a reactor system employing first and second polymerization reactors that are either continuously stirred tank reactors (CSTR) or plug-flow reactors. In an embodiment, a polymerization reactor for the production of a styrenic copolymer of the type disclosed herein including a plurality of reactors may have the first reactor (e.g. a CSTR), also known as the prepolymerization reactor, operated in the temperature range of from 90° C. to 135° C. while the second reactor (e.g. CSTR or plug flow) may be operated in the range of from 100° C. to 165° C.

The polymerized product effluent from the first reactor may be referred to herein as the prepolymer. When the prepolymer reaches the desired conversion, it may be passed through a heating device into a second reactor for further polymerization. The polymerized product effluent from the second reactor may be further processed and described in detail in the literature. Upon completion of the polymerization reaction, a styrenic polymer is recovered and subsequently processed, for example devolatized, pelletized, etc.

In an embodiment, the polymeric material (e.g., HIPS, GPPS, etc.) used to form one or more layers of the RWPA may also include additives as deemed necessary to impart desired physical properties, such as, increased gloss or color. Examples of additives include without limitation stabilizers, chain transfer agents, talc, antioxidants, UV stabilizers, lubricants, plasticizers, ultra-violet screening agents, oxidants, anti-oxidants, anti-static agents, ultraviolet light absorbents, fire retardants, processing oils, mold release agents, coloring agents, pigments/dyes, fillers, and the like. The aforementioned additives may be used either singularly or in combination to form various formulations of the composition. For example, stabilizers or stabilization agents may be employed to help protect the polymeric composition from degradation due to exposure to excessive temperatures and/or ultraviolet light. These additives may be included in amounts effective to impart the desired properties. Effective additive amounts and processes for inclusion of these additives to polymeric compositions may be determined by one skilled in the art with the aid of this disclosure. For example, one or more additives may be added after recovery of the styrenic polymer, for example during compounding such as pelletization. Alternatively or additionally to the inclusion of such additives in the styrenic polymer component of the RWPAs, such additives may be added during formation of the one or more layers of the RWPAs or to one or more other components and/or layers of the RWPAs. In an embodiment, additives may be present in the RWPA, in total or in one or more particular layer(s), in an amount of from 0.01 wt. % to 50 wt. %, alternatively from 0.2 wt. % to 30 wt. %, alternatively from 0.5 wt. % to 20 wt. % based on the total weight of the RWPA.

In an embodiment, ESCR (Environmental Stress Crack Resistance) enhancing additives may be added to the HIPS composition. The ESCR-enhancing additives may be added to the initial monomer/rubber feed stream or at any point in the polymerization process up to and including the final polymerization reactor. In an embodiment, the ESCR-enhancing additives include PIB, mineral oil, or combinations thereof. In an alternative embodiment, the PIB, mineral oil, or combinations thereof are present in amounts of 0.01 to 5.0% by weight of the final product. In another embodiment, the PIB, mineral oil, or combinations thereof are present in amounts of 0.5 to 3.0% by weight of the final product, optionally from 0.5 to 2.5 wt %, optionally from 0.5 to 2.0 wt %. In a further embodiment, both PIB and mineral oil are each present in amounts of from 1.0 to 3.0% by weight of the final product. In an embodiment an ESCR-enhanced material is used for the interior of a container, such as a cooler, that can be in contact with items that can induce environmental stress cracking.

In an embodiment, the RWPA includes at least one foamed polymeric layer. The foamed polymeric layer may be prepared from a composition including a styrenic polymer and a foaming agent. The styrenic polymer may be of the type described previously herein. The foaming agent may be any foaming agent compatible with the other components of the RWPA such as for example physical blowing agents, chemical blowing agents, and the like.

In an embodiment, the foaming agent is a physical blowing agent. Physical blowing agents are typically nonflammable gases that are able to evacuate the composition quickly after the foam is formed. Examples of physical blowing agents include without limitation pentane, carbon dioxide, nitrogen, water vapor, propane, n-butane, isobutane, n-pentane, 2,3-dimethylpropane, 1-pentene, cyclopentene, n-hexane, 2-methylpentane, 3-methylpentane, 2,3-dimethylbutane, 1-hexene, cyclohexane, n-heptane, 2-methylhexane, 2,2-dimethylpentane, 2,3-dimethylpentane, and the like. In an embodiment, the physical blowing agent is incorporated into the polymeric composition (e.g., a molten composition) in an amount of from 0.1 wt. % to 10 wt. %, alternatively from 0.1 wt. % to 5.0 wt. %, alternatively from 0.5 wt. % to 2.5 wt. % wherein the weight percent is based on the total weight of the foamed composition. The foamed composition may be formed into one or more foamed layers of the RWPA.

In an embodiment, the foaming agent is a chemical foaming agent, which may also be referred to as a chemical blowing agent. A chemical foaming agent is a chemical compound that decomposes endothermically at elevated temperatures. A chemical foaming agent suitable for use in this disclosure may decompose at temperatures of from 250° F. (121° C.) to 570° F. (299° C.), alternatively from 330° F. (165° C.) to 400° F. (204° C.). Decomposition of the chemical foaming agent generates gases that become entrained in the polymer, thus leading to the formation of voids within the polymer. In an embodiment, a chemical foaming agent suitable for use in this disclosure may have a total gas evolution of from 20 ml/g to 200 ml/g, alternatively from 75 ml/g to 150 ml/g, alternatively from 110 ml/g to 130 ml/g; resulting in the foamed composition having a bulk density of from 0.25 g/cc to 1.0 g/cc, alternatively from 0.50 g/cc to 0.99 g/cc, alternatively from 0.70 g/cc to 0.99 g/cc. Examples of chemical foaming agents suitable for use in this disclosure include without limitation SAFOAM FP-20, SAFOAM FP-40, SAFOAM FPN3-40, all of which are commercially available from Reedy International Corporation. In a non-limiting example, the chemical foaming agent (e.g., SAFOAM FP-40) has generally the physical properties set forth in Table 2.

TABLE 2

| | SAFOAM FP-40 |
|---|---|
| Properties | Typical Values |
| Total Gas Evolution | 120 ± 20 ml/g |
| Bulk Density | 0.70 ± 0.10 g/cc |
| Decomposition | 330° F. (165° C.) to 400° F. (204° C.) |
| Temperature | |

In an embodiment, the chemical foaming agent may be incorporated in the polymeric composition in an amount of from 0.10 wt. % to 5 wt. % by total weight of the polymeric composition, alternatively from 0.25 wt. % to 2.5 wt. %, alternatively from 0.5 wt. % to 2 wt. %. Upon heating the chemical foaming agent functions to yield a foamed polymer composition, which may be formed into one or more layers of the RWPA as described in detail herein.

In an embodiment, the foamed polymeric composition is prepared by contacting the polymer with the foaming agent, and thoroughly mixing the components for example by compounding or extrusion. In an embodiment, the polymer is plasticized or melted by heating in an extruder and is contacted and mixed thoroughly with foaming agent at a temperature of less than 350° F. Alternatively, the polymer may be contacted with the foaming agent prior to introduction of the mixture to the extruder (e.g., via bulk mixing), during the introduction of the styrenic polymer to an extruder, or combinations thereof. Methods for preparing a foamed polymer composition are described in U.S. Pat. Nos. 5,006,566 and 6,387,968, each of which is incorporated by reference herein in its entirety.

In an embodiment, the RWPA is a single layer structure in which the single layer is a foamed layer. The foamed layer may be produced using any method suitable for the production of such materials, such as those described above.

In an embodiment, the RWPA is a multilayer structure including one or more solid layers and one or more foamed layers that may be produced using any method suitable for the production of such materials. Any order of foamed and/or solid layers may be employed, for example one or more foamed layers sandwiched between one or more solid layers. For example, the RWPA may be produced by a co-extrusion cast process wherein one or more polymers are melted and at least one polymer is melted and foamed. Processes for melting and foaming the polymeric compositions have been described previously herein.

In an embodiment, molten polymer and foamed molten polymer are coextruded through a slot or die with two or more orifices arranged such that the extruded sheets merge and form a composite extruded sheet including one or more foamed layers and one or more solid layers. Accordingly, the composite extruded sheet may have one or more solid sheets, which become solid layers in the RWPA, and at least one foamed sheet, which becomes a foamed layer in the RWPA. In an embodiment, the RWPA includes a composite extruded sheet having a foamed inner layer surrounded or sandwiched between two solid layers. In an alternative embodiment, the molten polymer may then exit through a die and the molten plaque may be used to form a cast sheet, an oriented sheet, or the like. For example, the molten plaque may exit through the die and be uniaxially stretched while being taken up onto a chill roller where it is cooled to produce a cast film. The RWPA may have a thickness of greater than ¼-inch, alternatively greater than ½-inch, alternatively greater than 1-inch. In an embodiment, the RWPA may have a thickness of less than 5 inches, alternatively less than 3 inches, alternatively less than 2 inches. In another embodiment, the RWPA may have a thickness ranging from 0.1 inch to 5 inches, alternatively ranging from 0.25 inch to 4 inches, alternatively ranging from 0.5 inch to 2 inches.

In an embodiment, the single foamed sheet RWPA and/or the multilayer RWPA including one or more solid layers and one or more foamed layers may be further shaped and/or formed into end use articles or components by methods such as thermoforming. In an embodiment, the thermoforming is carried out at temperatures ranging from 120° C. to 165° C., alternatively from 125° C. to 160° C., alternatively from 130° C. to 155° C. In an embodiment, the RWPA sheet may be thermoformed into an article wherein the energy consumption required for thermoforming the RWPA is reduced, for example from 5% to 75%, alternatively 5% to 50%, alternatively 5% to 25%, when compared to the energy required to thermoform a solid structure (i.e., lacking a foamed layer) of similar materials for similar uses. Likewise, thermoformer operating temperatures can be reduced, for example from 1% to 7%, alternatively 2% to 6% percent, alternatively 3% to 5% percent, when compared to the energy required to thermoform a solid structure (i.e., lacking a foamed layer) of similar materials for similar uses.

In an embodiment, the RWPA is oriented. Generally, orientation of a polymer composition refers to the process whereby directionality (the orientation of molecules relative to each other) is imposed upon the polymeric arrangements in the film. Such orientation is employed to impart desirable properties to films, such as toughness and opaqueness, for example.

In an embodiment, the RWPA includes a single foamed layer. In another embodiment, the RWPA includes one or more solid layers and at least one foamed layer. Consequently, the RWPA may have two or more total layers, such as for example 2, 3, 4, or 5 layers.

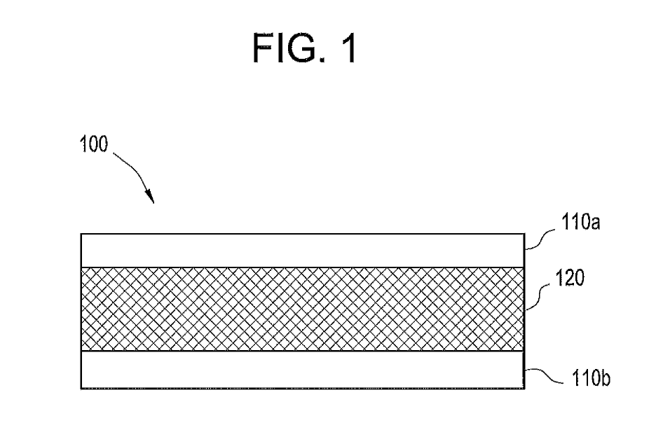

In an embodiment, the RWPA is a multilayer polymeric sheet including three layers as illustrated in FIG. 1. Referring to FIG. 1, an RWPA 100 includes a foamed inner core layer 120 disposed between two solid outer layers 110 (a,b). The solid outer layers 110a and 110b may include the same polymeric material as the core layer 120 with the distinction that the core layer is prepared from a foamed polymeric composition. In an embodiment, the core layer 120 is a different composition than the outer layers 110 (a,b). In such embodiments, the resultant article is said to have an “A-B-A” structure. In an embodiment two solid outer layers 110 (a,b) are both made from the same polymeric material, in an alternate embodiment the two solid outer layers 110 (a,b) are made from different polymeric materials.

In alternative embodiments, the solid outer layers and inner core layer may each be comprised of different polymeric compositions wherein the core layer includes a foamed polymeric composition and the resultant article is said to have an “A-B-C” structure. For example, layers A, B, and C may be prepared from polymeric compositions X, Y, and Z respectively wherein Y is a foamed polymeric composition used to prepare the inner core layer B.

The thickness of the individual layers (e.g. Outer layers A and/or C and core layer B in an A-B-A or A-B-C structure) may be selected by one of ordinary skill in the art with the aid of this disclosure to achieve user-desired properties (i.e., weight reduction, tensile properties, impact properties, etc.). In an embodiment, the thickness of the outer layers, e.g., A and/or C layers, may constitute from 5% to 50% of the total thickness of the RWPA, alternatively from 10% to 40%, alternatively from 20% to 40%. In an embodiment, the thickness of the B layer may constitute from 50% to 95% of the total thickness of the RWPA, alternatively from 60% to 90%, alternatively from 60% to 80%. In an embodiment, both the A material and the C material are solids. In another embodiment, A and C are both HIPS materials.

The thickness of the A and/or C layers may range from 0.01 inch to 2.5 inches, optionally from 0.1 to 1.5 inches, optionally from 0.3 to 1 inch. The thickness of the B layer may range from 0.1 inch to 4 inches, optionally from 0.3 to 3 inches, optionally from 0.5 to 2 inches.

In an embodiment, the RWPA may have a reduced weight when compared to an otherwise similar article lacking a foamed layer. This may be reflected by the reduced density of an RWPA when compared to an otherwise similar article lacking a foamed polymeric layer. Density is the ratio of mass per unit volume. In an embodiment, the RWPA may exhibit a density of from 0.25 g/cc to 1 g/cc, alternatively from 0.5 g/cc to 0.99 g/cc, alternatively from 0.7 g/cc to 0.99 g/cc. In another embodiment, the RWPA may exhibit a reduction in density when compared to an otherwise similar multilayer polymeric sheet in the absence of the foamed polymer layer of from 5.0% to 75%, alternatively from 5% to 52%, alternatively from 5% to 32%.

In an embodiment, the RWPA includes a foamed layer (e.g., foamed polystyrene) sandwiched between two solid layers (e.g., solid polystyrene such as HIPS), wherein the RWPA has a total thickness of from 0.060 inch to 0.50 inch, alternatively from 0.070 inch to 0.35 inch, alternatively from 0.080 inch to 0.170 inch; wherein the RWPA (foamed layer+2 solid layers) has a density of from 0.6 g/cc to 1.0 g/cc, alternatively from 0.75 g/cc to 1.0 g/cc, alternatively from 0.9 g/cc to 1.0 g/cc. In such an embodiment, the solid layers have a thickness of from 5% to 40% of the total thickness of the RWPA, alternatively from 10% to 30% and the foamed layer has a thickness of from 60% to 95% of the total thickness of the RWPA, alternatively from 70% to 90%. In such an embodiment, the solid layers may have a density from 0.9 g/cc to 1.8 g/cc, alternatively from 0.95 g/cc to 1.5 g/cc, alternatively from 1.03 g/cc to 1.06 g/cc and the foamed layers may have density of from 0.25 g/cc to 1.0 g/cc, alternatively from 0.5 g/cc to 0.99 g/cc, alternatively from 0.7 g/cc to 0.99 g/cc.

In an embodiment, the foamed or expanded material may be selected from the group of high-impact polystyrene (HIPS), high-heat crystal polystyrene (HHC), styrene-butadiene rubber (SBR), and phenoxy resin (PO) and combinations thereof. In another embodiment, the foamed or expanded material can be selected from the group of high flow general purpose polystyrene (GPPS) and PO and combinations thereof. In an even further embodiment, the foamed or expanded material includes expanded polystyrene, or low density expanded polystyrene.

In an embodiment, an RWPA of the type described herein is opaque. Opaque articles generally have a porosity that is measured by a bulk density. In an embodiment, an RWPA of the type described herein may have an increased opacity when compared to an otherwise similar article lacking a foamed layer.

In an embodiment, the RWPA may be colored by the addition of a coloring agent, such as a dye or a pigment. Such dyes and/or pigments and amounts necessary to achieve a user-desired coloring of the RWPA may be designed and chosen by one of ordinary skill in the art with the benefit of this disclosure. Due to the opacity of the RWPA (i.e., increased porosity) a reduced amount of a coloring agent may be employed to achieve a user-desired coloring when compared to otherwise similar articles lacking a foamed layer. In an embodiment the amount of coloring agent used may be reduced by at least 1 wt %, optionally at least 5 wt %, optionally at least 10 wt %, optionally at least 20 wt %, as compared to otherwise similar articles lacking a foamed layer.

The RWPAs of this disclosure may be converted to end-use articles. Examples of end use articles into which the RWPAs of this disclosure may be formed include disposable and non-disposable coolers and ice chests, liners (for cabinet, doors, appliances, refrigerators), food packaging, office supplies, plastic lumber, replacement lumber, patio decking, structural supports, laminate flooring compositions, polymeric foam substrate, decorative surfaces (e.g., crown molding, etc.), weatherable outdoor materials, point-of-purchase signs and displays, housewares and consumer goods, building insulation, cosmetics packaging, outdoor replacement materials, lids and containers (i.e. for deli, fruit, candies and cookies), appliances, utensils, electronic parts, automotive parts, enclosures, protective head gear, reusable paintballs, toys, musical instruments, golf club heads, piping, business machines and telephone components, shower heads, door handles, faucet handles, wheel covers, automotive front grilles, and so forth.

In an embodiment, the RWPA is formed into a disposable cooler or ice chest. The exterior of the end-use articles can have a surface that is readily printed on or that has a pattern that is on the outer layer, such as decorative designs, camouflaging, reflective or that is advertising for a product. The interior of the end-use articles can have a surface that is ESCR resistant. A polyolefin containing material may be positioned over or otherwise attached to the outer surface of the exterior of the end-use articles. The polyolefin containing materials may include polyethylene, polypropylene, etc.

RWPAs of the type described herein may display desirable properties when compared to an otherwise similar article lacking a foamed polymeric layer. Herein, property comparisons (e.g., impact, tensile, shrinkage, etc.) are being made in comparison to an otherwise similar article lacking a foamed polymeric layer.

In an embodiment, an RWPA of the type described herein may exhibit a Gardner impact of from 5 in-lbs to 50 in-lbs, alternatively from 10 in-lbs to 40 in-lbs, alternatively from 16 in-lbs to 30 in-lbs. Gardner impact, also known as Falling Dart impact, is measured using a weighted dart that is dropped onto a flat plaque from varying heights. The 50% failure height is determined to be the Gardner impact, as determined in accordance with ASTM 3029 Method G.

In an embodiment, an RWPA of the type described herein may exhibit a tensile strength at yield of from 1000 psi to 2000 psi, alternatively from 1100 psi to 1900 psi, alternatively from 1300 psi to 1800 psi. The tensile strength at yield is the force per unit area required to yield a material, as determined in accordance with ASTM D882.

In an embodiment, an RWPA of the type described herein may exhibit a tensile strength at break of from 500 psi to 3000 psi, alternatively from 1000 psi to 2500 psi, alternatively from 1500 psi to 2000 psi. The tensile strength at break is the force per unit area to break a material, as determined in accordance with ASTM D882.

In an embodiment, an RWPA of the type described herein may exhibit an elongation at yield of from 1% to 3%, alternatively from 1.2% to 2.5%, alternatively from 1.5% to 2.0%. The elongation at yield is the percentage increase in length that occurs at the yield point of a material, as determined in accordance with ASTM D882.

In an embodiment, an RWPA of the type described herein may exhibit an elongation at break of from 15% to 80%, alternatively from 20% to 60%, alternatively from 25% to 40%. The elongation at break is the percentage increase in length that occurs before a material break under tension, as determined in accordance with ASTM D882.

In an embodiment, an RWPA of the type described herein may exhibit a shrinkage of from 0% to 40%, alternatively from 0% to 20%, alternatively from 0% to 10%. The shrinkage may be calculated by first measuring the length of contraction upon cooling in the in-flow direction (MD) and in the cross-flow direction (TD). The difference in the MD and TD at a given temperature, multiplied by 100% gives the percent shrinkage.

In an embodiment, the present invention is directed to a method of forming a laminate having at least 2 types of material and at least 3 layers. In another embodiment, the present invention includes a method of forming a coextruded sheet having at least 2 types of material and at least 3 layers. In a further embodiment, the present invention includes a method of thermoforming at least 2 types of material in at least 3 layers to form a thermoformed article.

In an embodiment, the method includes coextruding a sheet with an A-B-A structure. In another embodiment, the method includes coextruding a sheet with an A-B-C structure. In an embodiment, the A material and the C material are solids. The B material may be foamed or expanded. In an embodiment, the foamed or expanded material may be selected from the group of high-impact polystyrene (HIPS), high-heat crystal polystyrene (HHC), styrene-butadiene rubber (SBR), and phenoxy resin (PO) and combinations thereof. The B material may be expanded with any known blowing agent including physical and/or chemical blowing agents. In an embodiment, the blowing agent can include expandable microspheres, such as Expancel® expandable microspheres available from Akzo Nobel N.V.

In another embodiment, the method includes coextruding a sheet with an A-B-A structure that foams when thermoformed. In another embodiment, the method includes coextruding a sheet with an A-B-C structure that foams when thermoformed. In an embodiment, the A material and the C material are solids. In another embodiment, A and C are HIPS materials. In an aspect, the B material can be selected from the group of high flow general purpose polystyrene (GPPS) and PO and combinations thereof. In another aspect, the B material may include a chemical blowing agent (CBA). In an aspect, the CBA is activated, or foams, when the coextruded sheet is thermoformed. In an embodiment the B material can include components that are compatible with polystyrene, can include components that are incompatible with polystyrene, and can include combinations thereof.

In yet another embodiment, the method includes coextruding a sheet with an A-B-A structure, wherein the two A materials are separated from a single sheet during forming thereby creating a void space. In another embodiment, the method includes coextruding a sheet with an A-B-C structure, wherein the A material and C material separate during forming, thereby creating a void space between the separated A material and C material. In an embodiment, the A material and the C material are HIPS. In an aspect, the B material may contain a CBA. In another aspect, the B material is added to the void space between the two A layers or the A and C layers. In a further aspect, the B material may be selected from the group of PO and any other resin that is incompatible with polystyrene and combinations thereof. The B material can be added to the void space by any known means, such as by injecting the material with a CBA for in-situ foaming or by inserting material that is already foamed, such as foamed beads, in sufficient quantities to substantially fill the void space.

In a further embodiment, the method includes adhering a solid HIPS sheet to a low-density expanded polystyrene foam board to obtain a layered sheet. The layered sheet is then thermoformed into a RWPA.

In an even further embodiment, the method includes thermoforming a single layered sheet of a foamed material to obtain a thermoformed RWPA. In an embodiment, the foamed material is expanded polystyrene.

In an embodiment, the final shaped materials containing a foamed material can be obtained by any method, including methods selected from the group of billow plug assist, thermoforming, drape forming, vacuum forming, snap back forming using a male mold, and combinations thereof. In another embodiment, the shaped materials can be formed by matched metal forming. In a further embodiment, the shaped materials can be formed using extrusion and/or co-extrusion and thermoforming. In an aspect, the blowing agent for creating the foam in the foamed material may include CO₂. In another aspect, the foam in the foamed material is created without a blowing agent.

The present invention also includes a method of thermoforming a RWPA having at least one foamed layer. In an embodiment, the method includes, heating a sheet having at least one foamed layer and conforming the sheet to a mold. In another embodiment, the method includes heating a sheet having at least one foamed layer, placing the heated sheet onto a mold, closing the mold onto the sheet, and applying a vacuum or pressure to the mold thereby forming the molded shape of the sheet. In an embodiment, the heated sheet having at least one foamed layer has a thickness of a thickness of greater than ¼-inch, alternatively greater than ½-inch, alternatively greater than 1-inch. In another embodiment, the thermoformed RWPA has a thickness of greater than ¼-inch, alternatively greater than ½-inch, alternatively greater than 1-inch.

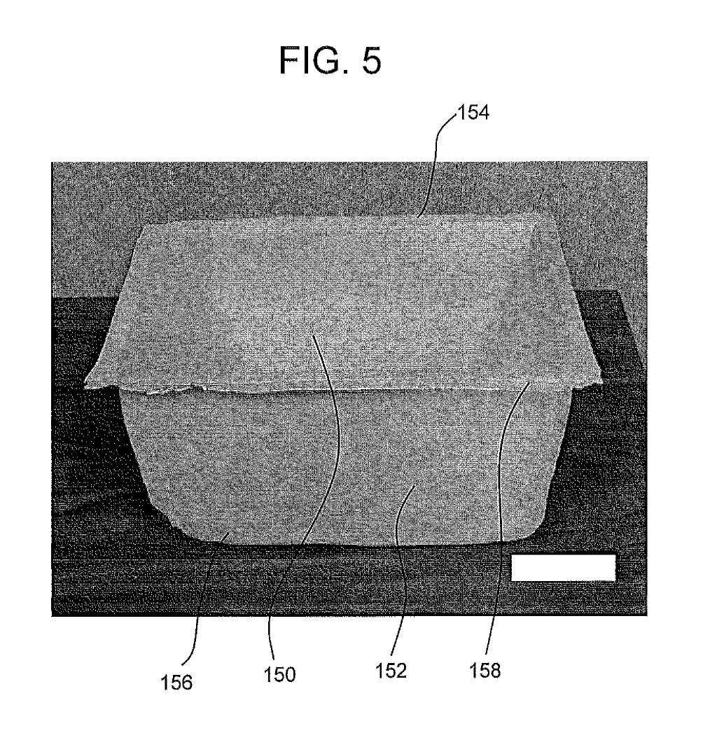

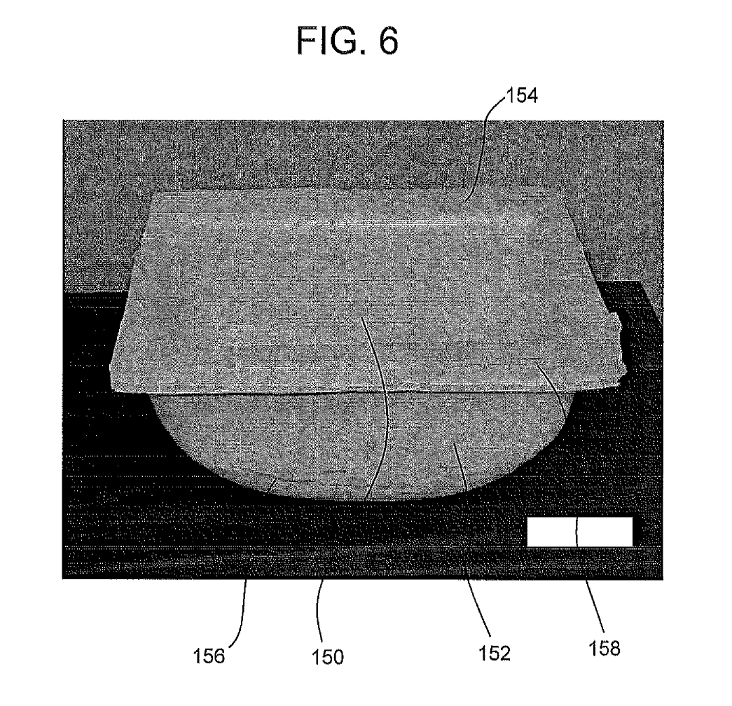

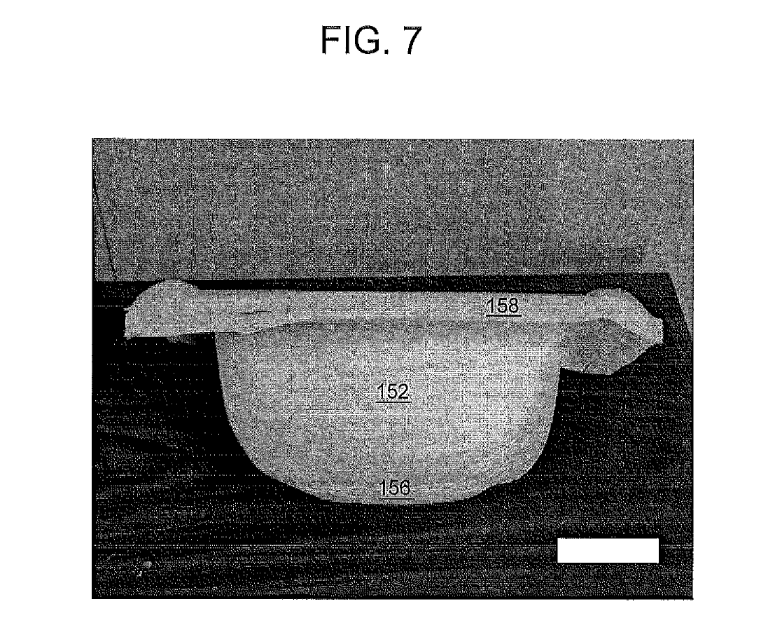

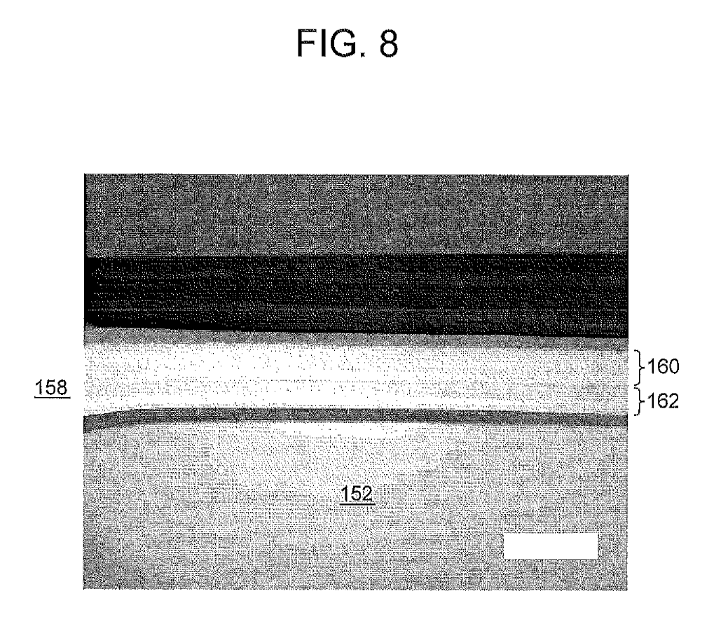

FIGS. 5, 6, 7 and 8 illustrate prototype parts made with various embodiments of the present invention. An interior 150, exterior 152, top 154, bottom 156 and lip 158 sections are formed. FIG. 5 illustrates a generally squared bottom section 156, while FIGS. 6 and 7 illustrate a generally rounded bottom section 156. FIG. 8 is a photo of two sheets 160, 162, of foam board adhered during a thermoforming process in accordance with an embodiment of the present invention. A side view of the lip section 158 illustrates that the two sheets 160, 162 are adhered to each other.

The present invention has several advantages over traditional disposable expanded polystyrene coolers. For example, the hard surfaces of the present invention will provide a better quality-printing surface and is able to receive laminate printed film, such as camouflage, flags of countries, and wood grain. In addition, the hard surfaces can contain varying gloss levels and embossed patterns. Furthermore, the product of the present invention can be made UV stable by coextruding a Solarkote® layer or laminating with a UV stable film.

### EXAMPLES

The disclosure having been generally described, the following examples are given as particular embodiments of the disclosure and to demonstrate the practice and advantages thereof. It is understood that the examples are given by way of illustration and are not intended to limit the specification or the claims to follow in any manner.

### Example 1

A ½″ thick foamed board was produced by adhering a solid HIPS sheet to a low-density expanded polystyrene foam board in a A-B-A configuration. The foamed board was thermoformed into the approximate shape of a cooler. The experiment showed that polystyrene sheets containing a foamed layer can be thermoformed. FIG. 5 is a photograph of the thermoformed cooler. The three layers can be seen by the side view of the lip section 158.

### Example 2

A 1″ thick foamed board was produced by adhering a solid HIPS sheet to a low-density expanded polystyrene foam board in a A-B-A configuration. The foamed board was thermoformed into the approximate shape of a cooler. The experiment showed that polystyrene sheets containing a foamed layer can be thermoformed. FIG. 6 is a photograph of the thermoformed cooler.

### Example 3

The tensile properties of three reduced weight multilayer polymeric sheets (RWPAs) designated Samples 2-4, of varying densities were investigated and compared to a single layer polymer sheet (Sample 1). All samples were prepared using 960E, which is a HIPS commercially available from Total Petrochemicals USA, Inc. and the orientation of the samples was held constant. Samples 2-4 contained a foamed polymeric layer which was prepared using 960E and SAFOAM® FP-40 blowing agent available from Reedy International Corporation at 0.5 wt. % concentration.

Sample 1 was produced by sheet extrusion using a mini-coex line. Samples 2-4 were constructed by coextrusion and resulted in an “A-B-A” structure as illustrated in FIG. 1. The processing conditions are tabulated in Table 3.

TABLE 3
MAIN

| Zone 1 | 360° F. |
|---|---|
| Zone 2 | 375° F. |
| Zone 3 | 395° F. |
| Zone 4 | 405° F. |
| Clamp Ring | 405° F. |
| Adaptor | 405° F. |
| Feedblock | 415° F. |
| Die | 420° F. |
| Melt | 402° F. |
| Pressure | 2100 psi |
| R.P.M | 108 |
| % Load | 52 |

TAKE OFF

| | |
|---|---|
| Top Roll | 195° F. |
| Mid Roll | 200° F. |
| Bottom Roll | 195° F. |
| F.P.M | 2.46 |
| Pull Ratio | 1.1 |

Referring to FIG. 1, a multilayer film 100 has outer layers 110 a and b that can be constructed from solid 960E, which for Samples 2-4 each has a % thickness of 10%, 20%, and 30% respectively. Layer 120 is foamed 960E, which for Samples 2-4 each has a % thickness of 80%, 60%, and 40% respectively. All samples were prepared at a target sheet gauge of 70 mils for the total multilayer film. The ESCR, density, impact properties, tensile properties, and shrinkage properties were determined for all samples in accordance with the methodologies described previously herein and the results are tabulated in Table 4.

TABLE 4

| | | Sample 2 | Sample 3 | Sample 4 |
|---|---|---|---|---|
| | | 10% Solid | 20% Solid | 30% Solid |
| | Sample 1 | Outer Layers | Outer Layers | Outer Layers |
| | 960E | 80% Foamed | 60% Foamed | 40% Foamed |
| | Solid | Inner Core | Inner Core | Inner Core |
| Properties | Layer | Layer | Layer | Layer |
| Density (g/cc) | 1.04 | 0.88 | 0.92 | 0.96 |
| Percent Change | 0.0 | 14.6 | 10.7 | 6.8 |
| (vs. solid sheet) | | | | |
| Gardner Impact | 42.1 | 16.6 | 22.0 | 30.1 |
| (in-lbs.) | | | | |
| Tensile Strength at | 2084 | 1363 | 1566 | 1722 |
| Yield (MD) psi | | | | |
| Tensile Strength at | 2565 | 1676 | 1873 | 2016 |
| Break (MD) psi | | | | |
| Elongation at | 1.9 | 1.8 | 1.8 | 1.9 |
| Yield (MD) % | | | | |
| Elongation at | 29.7 | 35.7 | 37.4 | 37.7 |
| Break (MD) % | | | | |
| Tensile Strength at | 2120 | 1366 | 1596 | 1780 |
| Yield (TD) psi | | | | |
| Tensile Strength at | 2527 | 1584 | 1794 | 1888 |
| Break (TD) psi | | | | |
| Elongation at | 2.0 | 1.8 | 1.8 | 1.9 |
| Yield (TD) % | | | | |
| Elongation at | 62.9 | 30.6 | 33.5 | 32.3 |
| Break (TD) % | | | | |
| Shrinkage (MD) % | 6.7 | 2.3 | 1.5 | 2.2 |
| Shrinkage (TD) % | 0.0 | 0.0 | 0.0 | 0.0 |
| ESCR (Visual) | No crazes | No crazes or | No crazes or | No crazes or |
| | or cracks | cracks | cracks | cracks |

Referring to Table 4, Samples 2, 3, and 4 had a density that was reduced by 14.6%, 10.7%, and 6.8% respectively when compared to Sample 1.

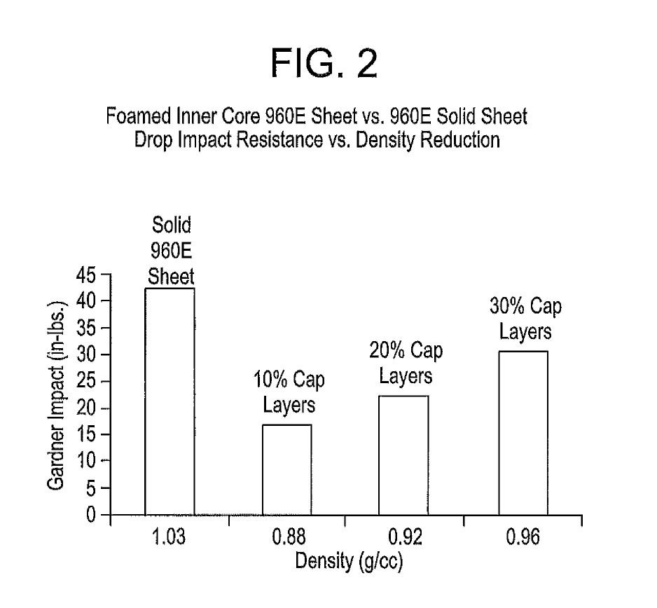

FIG. 2 is a plot of Gardner impact as a function of density for these samples. As the density decreased the Gardner impact for Samples 2-4 also decreased when compared to the impact strength determined for Sample 1. This trend was expected since the weights of Samples 2-4 were reduced. The percent elongation results showed a rapid loss of ductility with the samples having a foamed layer exhibiting a roughly 50% reduction in elongation.

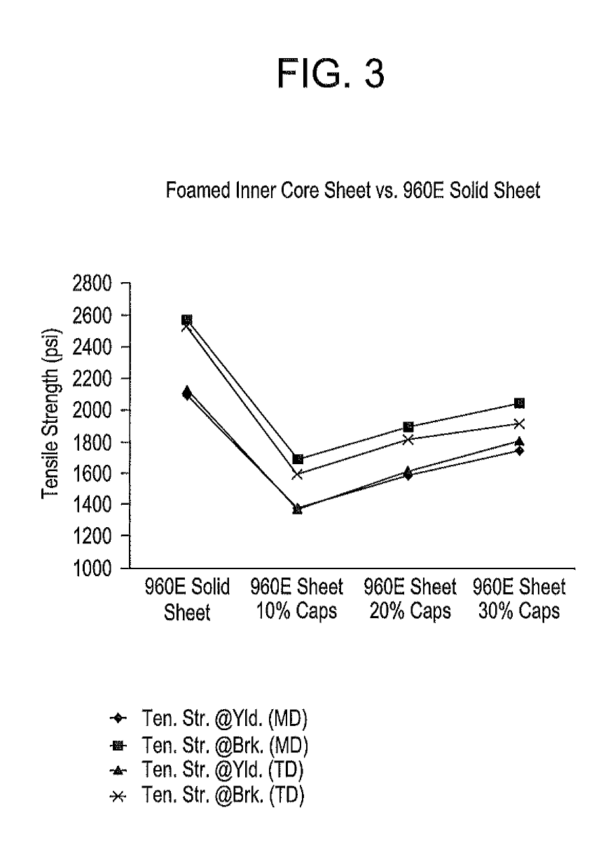

FIG. 3 is a plot of tensile strength properties for Samples 1-4. Similarly, as density decreased, the tensile strength properties for Samples 2-4 also decreased when compared to Sample 1. Samples 2-4 also showed an increase in elongation at break in the MD, with a decrease in the elongation at break in the TD.

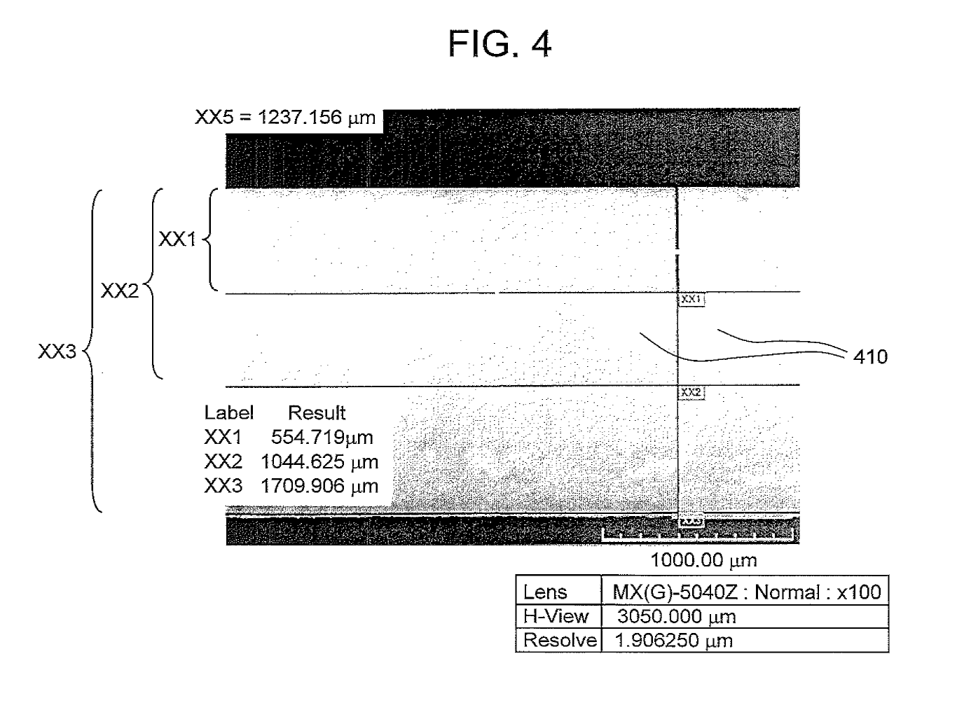

FIG. 4 is a photomicrograph of a foamed inner core layer for Sample 4. Referring to FIG. 4, the image shows a number of voids 410 within the HIPS. In addition, the thicknesses of the solid outer layer (e.g., top and bottom), as well as the thickness of the inner core foamed layer were determined. XX1 is the solid outer top layer, XX2 is the combination of the solid outer top layer and the inner core foamed layer, XX3 is the total of the solid outer top layer, the inner core foamed layer, and the solid outer bottom layer. The thickness of XX1, XX2, and XX3 were 554.7 μm, 1044.6 μm, and 1709.9 μm respectively. Thus, the thicknesses of the solid outer top layer, the inner core foamed layer, and the solid outer bottom layer for Sample 4 were determined to be about 554 μm, 490 μm, and 665 μm respectively.

### Example 4

Two 0.5″ thick low-density expanded polystyrene foam boards were placed adjacent to each other and were thermoformed into an article with the approximate shape of a cooler. The experiment showed that multiple polystyrene foam boards can be thermoformed into an article and that the thermoforming can adhere adjacent boards to each other. FIGS. 7 & 8 are photographs of the thermoformed article.

While embodiments of the disclosure have been shown and described, modifications thereof can be made by one skilled in the art without departing from the spirit and teachings of the disclosure. The embodiments described herein are exemplary only, and are not intended to be limiting. Many variations and modifications of the disclosure disclosed herein are possible and are within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.).

As used herein, the term “cooler” includes an “ice chest” or other insulated container that may be used to keep food and/or drink cool.

As used herein the term “opaque” means the article has a total white light transmission (TWLT) less than 10% and haze greater than 70%, as measured according to ASTM D1003 and E313.

Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

As used herein, the term “reduced weight polymeric article” or “RWPA” refers to polymeric articles having a reduced weight as compared to a substantially similar article made from the same or similar polymer that has not been foamed or expanded. The addition of the gaseous phase in a foamed or expanded polymeric component reduces the density of the polymeric component and therefore will result in a reduction in weight of articles made from the polymeric component.

Use of broader terms such as comprises, includes, having, etc. should be understood to provide support for narrower terms such as consisting of, consisting essentially of, comprised substantially of, etc.

The various aspects of the present invention can be joined in combination with other aspects of the invention and the listed embodiments herein are not meant to limit the invention. All combinations of various aspects of the invention are enabled, even if not given in a particular example herein.

Depending on the context, all references herein to the “invention” may in some cases refer to certain specific embodiments only. In other cases it may refer to subject matter recited in one or more, but not necessarily all, of the claims. While the foregoing is directed to embodiments, versions and examples of the present invention, which are included to enable a person of ordinary skill in the art to make and use the inventions when the information in this patent is combined with available information and technology, the inventions are not limited to only these particular embodiments, versions and examples. Also, it is within the scope of this disclosure that the aspects and embodiments disclosed herein are usable and combinable with every other embodiment and/or aspect disclosed herein, and consequently, this disclosure is enabling for any and all combinations of the embodiments and/or aspects disclosed herein. Other and further embodiments, versions and examples of the invention may be devised without departing from the basic scope thereof and the scope thereof is determined by the claims that follow.

What is claimed is:

1. A method of making a container comprising:
forming a polymeric sheet comprising at least one foam layer; and
thermoforming the polymeric sheet into a container;
wherein the container is an insulator.

2. The method of claim 1, wherein the polymeric sheet comprises polystyrene, polypropylene, polyethylene, polyethylene terephthalate, polyvinyl chloride, polyvinylidine chloride, polylactic acid, polyamide, polycarbonate, polytetrafluoroethylene, polyurethane, polyester, polymethyl methacrylate, polyoxymethylene, homopolymers thereof, copolymers thereof, or combinations thereof.

3. The method of claim 1, wherein the polymeric sheet comprises at least one foam layer and at least one solid layer disposed adjacent to the foam layer.

4. The method of claim 3, wherein the layers of the polymeric sheet are adhered to each other by coextrusion.

5. The method of claim 3, wherein the solid and foamed layers comprise polystyrene, and wherein the polystryrene is foamed by contacting the polystyrene with a foaming agent.

6. The method of claim 3, wherein the foam layer comprises expanded polystyrene and the solid layer comprises high impact polystyrene.

7. The method of claim 3, wherein the container comprises a foamed layer sandwiched between two solid layers.

8. The method of claim 3, wherein the container comprises a foamed expanded polystyrene layer sandwiched between two solid high impact polystyrene layers.

9. The method of claim 8, wherein the foamed layer has a thickness of 60% to 95% and each solid layer has a thickness of 5% to 40% based on the total thickness of the polymeric sheet.

10. The method of claim 8, wherein the foamed layer has a density of 0.25 g/cc to 1 g/cc and each solid layer has a density of 0.9 g/cc to 1.8 g/cc.

11. The method of claim 1, wherein the container has a density of from 0.25 g/cc to 1 g/cc.

12. The method of claim 1, wherein the polymeric sheet has a Gardner impact of from 5 in-lbs to 50 in-lbs.

13. The method of claim 1, wherein the polymeric sheet has a tensile strength at yield of from 1000 psi to 2000 psi.

14. The method of claim 1, wherein the polymeric sheet has a tensile strength at break of from 500 psi to 3000 psi.

15. The method of claim 1, wherein the polymeric sheet has an elongation at yield of from 1% to 3%.

16. The method of claim 1, wherein the polymeric sheet has an elongation at break of from 15% to 80%.

17. The method of claim 1, wherein the polymeric sheet has a shrinkage of from 0% to 40%.

18. The method of claim 1, wherein the polymeric sheet passes an environmental stress crack resistance test.

19. The method of claim 1, wherein the shaping comprises a method selected from the group consisting of billow plug assist, thermoforming, drape forming, vacuum forming, and snap back forming using a male mold and combinations thereof.

20. A container made by the method of claim 1.

21. A disposable cooler made by the process of claim 1.

22. A method of preparing a container comprising:
coextruding a foamed polystyrene layer between two solid layers of high impact polystyrene to form a sheet; and
thermoforming the sheet into the shape of a cooler.

23. The method of claim 22, wherein the thermoforming is carried out at a temperature of from 120° C. to 165° C.

24. A disposable cooler made by the process of claim 22.

25. A method of forming a polymeric article comprising:
extruding a foamed polymeric composition to form a sheet having at least one foamed layer; and
thermoforming the sheet into an article.

26. The method of claim 25, wherein the article is a container.

27. A method of making a cooler comprising:
forming a multilayer polymeric sheet comprising at least one foam layer and at least one solid layer disposed adjacent to the foam layer; and
shaping the multilayer polymeric sheet into a container;
wherein the container is an insulator;
wherein the layers of the sheet are adhered to each other by coextrusion.
